(19) United States
(12) Patent Application Publication
(10) Pub. No.: US 2025/0356640 A1
(43) Pub. Date: Nov. 20, 2025

(54) NON-TRANSITORY COMPUTER-READABLE RECORDING MEDIUM, MACHINE LEARNING METHOD, OPTIMIZATION METHOD, AND INFORMATION PROCESSING APPARATUS

(71) Applicant: Fujitsu Limited, Kawasaki-shi (JP)

(72) Inventors: Kimihiro YAMAZAKI, Ohta (JP); Akira NAKAGAWA, Sagamihara (JP); Yuichiro WADA, Setagaya (JP); Mutsuyo WADA, Funabashi (JP); Takashi KATOH, Kawasaki (JP)

(73) Assignee: Fujitsu Limited, Kawasaki-shi (JP)

(21) Appl. No.: 19/283,342

(22) Filed: Jul. 29, 2025

Related U.S. Application Data
(63) Continuation of application No. PCT/JP2023/045641, filed on Dec. 20, 2023.

(30) Foreign Application Priority Data
Jan. 31, 2023 (JP) 2023-012832

(51) Int. Cl. G06V 10/776; G06V 10/774; G06V 20/64

(52) U.S. Cl. CPC G06V 10/776; G06V 10/774; G06V 20/64

(57) ABSTRACT

A non-transitory computer-readable recording medium stores therein a machine learning program that causes a computer to execute a process including acquiring a second frequency image by inputting output of an encoder that has input a first frequency image to a decoder, and training the encoder and the decoder based on a loss function in which a weight related to a first frequency is smaller than a weight related to a second frequency higher than the first frequency, the first frequency image, and the second frequency image.

### CROSS-REFERENCE TO RELATED APPLICATION

This application is a continuation application of International Application No. PCT/JP2023/045641, filed on Dec. 20, 2023, which claims the benefit of priority of the prior Japanese Patent Application No. 2023-012832, filed on Jan. 31, 2023, the entire contents of which are incorporated herein by reference.

### FIELD

The present invention relates to a machine learning technique using a frequency image.

### BACKGROUND

There is a demand for estimating a three-dimensional density structure, which is difficult to be observed, based on projection images obtained by projecting the three-dimensional density structure in various angles. For example, a conventional technique has been used in which a three-dimensional density structure is estimated from projection images by using an auto-encoder type neural network.

FIG. 5 illustrates the conventional technique. As illustrated in FIG. 5, the auto-encoder type neural network includes an encoder 10a and a decoder 10b. Here, a device that executes processing of the conventional technique is referred to as a “conventional device”.

The conventional device generates a two-dimensional frequency image 5 by executing Fourier transform on a projection image 4 obtained by projecting a certain three-dimensional density structure in a certain projection direction R. The certain three-dimensional density structure includes a density structure of a protein. The conventional device acquires an output result z by inputting the frequency image 5 to the encoder 10a. The conventional device estimates a three-dimensional density structure 6 in Fourier space by inputting, to the decoder 10b, position information on the projection direction R in a case where the projection image 4 is projected and the output result z. The three-dimensional density structure in the real space is obtained by executing inverse Fourier transform on the three-dimensional density structure 6.

Here, the conventional device executes machine learning on the encoder 10a and the decoder 10b based on an evaluation function based on the difference (error) between the frequency image 5 and an estimated frequency image 7. The estimated frequency image 7 is obtained by projecting the three-dimensional density structure 6 in the projection direction R. For example, Expression (1) indicates an evaluation function L used by the conventional device.

$$ℒ ( X ; ξ , θ ) = {E}_{{q}_{ξ} ( z \vert X )} [ log p ( X \vert z ) ] - β KL ( {q}_{ξ} ( z \vert X ) \vert \vert p ( z ) ) \qquad ( 1 )$$

“X” in Expression (1) is a value corresponding to frequency coordinates of the frequency image 5. “ξ” and “θ” correspond to parameters of the encoder 10a and the decoder 10b, respectively. The first term on the right side of Expression (1) is a term of an expected value E for evaluating the difference between the frequency image 5 and the estimated frequency image 7. The second term on the right side of Expression (1) is defined by KL divergence, and has a value that decreases as the distribution of qξ(z|X) comes closer to the distribution of p(z). Note that qξ(z|X) approximates p (z|X). Here, p(z) follows a normal distribution of N(0, I). In addition, I is a unit matrix.

The conventional device executes machine learning of the encoder 10a and the decoder 10b so as to minimize the value of the evaluation function L in Expression (1).

Non Patent Literature 1: Ellen D. Zhong, et al. RECONSTRUCTING CONTINUOUS DISTRIBUTIONS OF 3D PROTEIN STRUCTURE FROM CRYO-EM IMAGES, arXiv: 1909.05215v3 (q-bio.QM) 15 Feb. 2020

### SUMMARY

According to an aspect of an embodiment, a non-transitory computer-readable recording medium stores therein a machine learning program that causes a computer to execute a process including acquiring a second frequency image by inputting output of an encoder that has input a first frequency image to a decoder, and training the encoder and the decoder based on a loss function in which a weight related to a first frequency is smaller than a weight related to a second frequency higher than the first frequency, the first frequency image, and the second frequency image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of an information processing apparatus according to an embodiment.

FIG. 2 is a flowchart illustrating a processing procedure of the information processing apparatus according to the embodiment.

FIG. 3 illustrates an example of optimization of a three-dimensional density structure.

FIG. 4 illustrates an example of a hardware configuration of a computer that implements functions similar to those of the information processing apparatus of the embodiment.

FIG. 5 illustrates a conventional technique.

FIG. 6 is a figure (1) illustrating a problem of the conventional technique.

FIG. 7 is a figure (2) illustrating the problem of the conventional technique.

FIG. 8 is a figure (3) illustrating the problem of the conventional technique.

### DESCRIPTION OF EMBODIMENTS

As described above, when executing machine learning, the conventional device uses the evaluation function L in Expression (1). For example, the conventional device evaluates the difference between a projection image of an actual protein and a projection image of an estimated three-dimensional density structure as the difference between the three-dimensional structures. A difference between two-dimensional frequency images is, however, not equivalent to a difference between three-dimensional density structures. Therefore, there is such a problem that the accuracy of estimating the three-dimensional density structure is influenced if machine learning is executed on the encoder 10a and the decoder 10b as in the conventional technique.

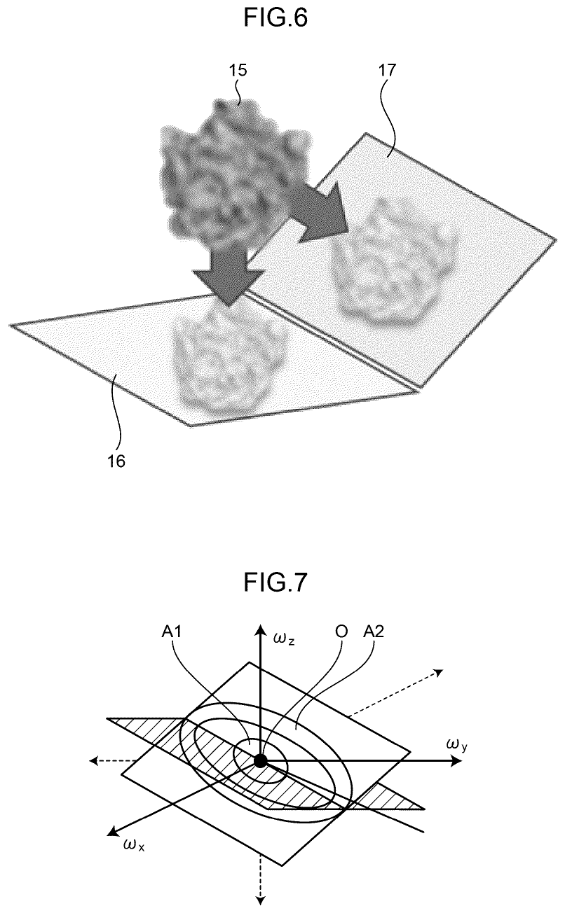

FIG. 6 is a figure (1) illustrating a problem of the conventional technique. For example, two-dimensional projection images obtained by projecting a certain three-dimensional density structure 15 in random projection directions are defined as projection images 16 and 17. FIG. 7 is obtained by executing Fourier transform on the projection images 16 and 17 and mapping the results of the Fourier transform in three-dimensional frequency space.

FIG. 7 is a figure (2) illustrating the problem of the conventional technique. In the three-dimensional frequency space, a frequency increases as the distance R from the origin 0 of the frequency increases. In the three-dimensional frequency space, an x component is defined as ωₓ. A y component is defined as ω_{y}. A z component is defined as ω_{z}. The distance R from the origin 0 in the three-dimensional frequency space is defined in Expression (2).

$$R = \sqrt{{ω}_{x}^{2} + {ω}_{y}^{2} + {ω}_{z}^{2}} \qquad ( 2 )$$

For example, the distance R of the area A1 is smaller than the distance R of the area A2. Therefore, the frequency of the area A1 is smaller than the frequency of the area A2.

Here, a frequency at the distance R is weighted with a weight of “1/R²” in accordance with the distance. This means that a value of a frequency at a smaller distance R is more weighted at a ratio of “1/R²” and the frequency is evaluated.

For example, when the difference between the frequency image 5 and the estimated frequency image 7 is calculated as it is as in the conventional technique, the difference is calculated with a weight on a value of a frequency included in the area A1 rather than on a value of a frequency included in the area A2. This is equivalent to comparing results of blurring a detailed structure of the three-dimensional density structure by using a low-pass filter with each other.

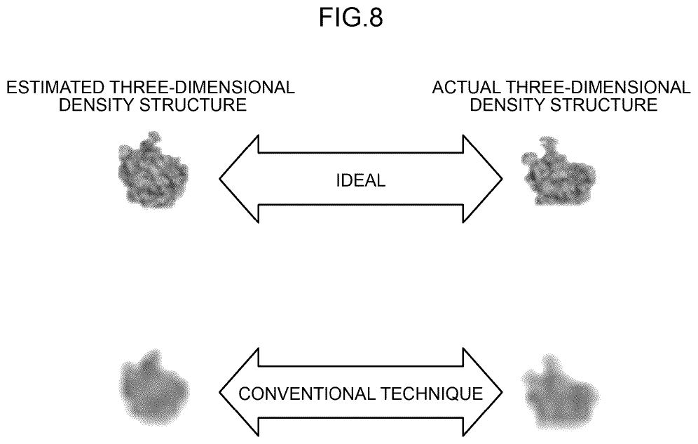

FIG. 8 is a figure (3) illustrating the problem of the conventional technique. As described above, in the conventional technique, results of blurring an estimated three-dimensional density structure and an actual three-dimensional density structure are compared with each other to calculate the difference therebetween, and the accuracy of estimating the three-dimensional density structure is deteriorated. Ideally, the difference between the estimated three-dimensional density structure and the actual three-dimensional density structure is desirably evaluated uniformly regardless of the frequency of a frequency image.

An embodiment of a machine learning program, an optimization program, a machine learning method, an optimization method, and an information processing apparatus disclosed in the present application will be described in detail below with reference to the drawings. Note that the embodiment does not limit the invention. Embodiment

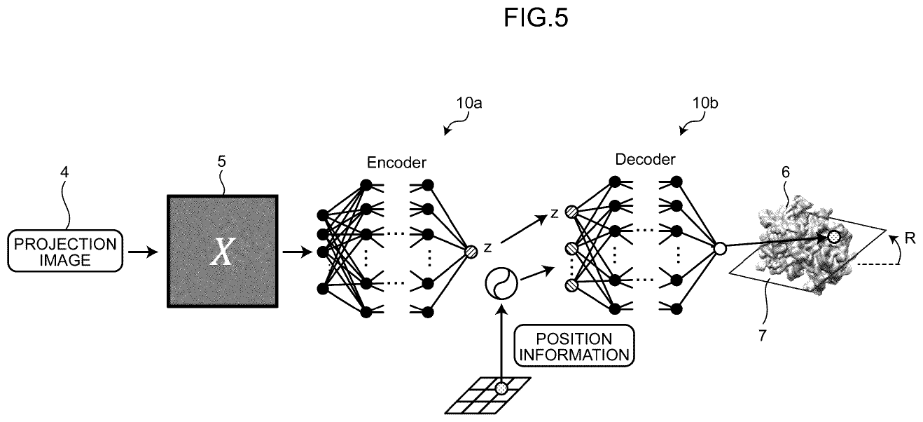

An information processing apparatus according to the embodiment inputs a first frequency image to an auto-encoder type neural network, and acquires a second frequency image. The information processing apparatus evaluates the difference between the first frequency image and the second frequency image, and executes machine learning of the auto-encoder type neural network. The first frequency image is an input image in CryoEM, and is the frequency image 5 or the like described with reference to FIG. 5. The second frequency image is an estimation image in CryoEM, and is the estimated frequency image 7 or the like described with reference to FIG. 5. The auto-encoder type neural network includes the encoder 10a and the decoder 10b.

As described with reference to FIG. 7, the frequency at the distance R is weighted with a weight of “1/R²” in accordance with the distance. A value of a frequency at a smaller distance R is more weighted at a ratio of “1/R²”. When the difference between the first frequency image and the second frequency image is calculated as it is, the difference (error) is calculated with a weight on a value of a low frequency rather than a value of a high frequency. For example, the difference is calculated with a weight on a value of a frequency included in the area A1 rather than on a value of a frequency included in the area A2. In the following description, the coordinates of a frequency image, which are the coordinates of two-dimensional Fourier transform, are referred to as “frequency coordinates”.

Here, in order to uniformly evaluate the difference between the first frequency image and the second frequency image regardless of the frequencies (frequency coordinates) of the frequency images, the information processing apparatus multiplies the differences (square errors) between the frequency coordinates at the distance R by R², and cumulatively adds the results. The distance R is defined by Expression (2). Since the frequency images are two-dimensional images, “ω_{z}” has a value of 0.

For example, when the difference between the first frequency image and the second frequency image is evaluated, the information processing apparatus sets (u′, v′) as frequency coordinates of two-dimensional Fourier transform, calculates a difference of the Fourier transform at the frequency coordinates (u′, v′) from the first frequency image and the second frequency image, and sets the difference as P_{θ, ϕ}(u′, v′). The information processing apparatus calculates an estimation error by using an evaluation function in Expression (3) using a correction filter coefficient F (u′, v′) defined for each of frequency coordinates. When calculating the estimation error, the information processing apparatus uses “u′²+v′²” as the correction filter coefficient F(u′, v′). The “u′²+v′²” corresponds to “R²”.

$${\sum }_{{u}^{′} , {v}^{′}} {{P}_{θ , ϕ} ( {u}^{′} , {v}^{′} )}^{2} F ( {u}^{′} , {v}^{′} ) \qquad ( 3 )$$

Here, a distance r₁ between frequency coordinates (u′₁, v′₁) and the origin on a frequency image is defined as in Expression (4). A distance r₂ between frequency coordinates (u′₂, v′₂) and the origin on the frequency image is defined as in Expression (5).

$${r}_{1} = \sqrt{{u}_{1}^{′2} + {v}_{1}^{′ 2}} \qquad ( 4 )$$

$${r}_{2} = \sqrt{{u}_{2}^{′2} + {v}_{2}^{′2}} \qquad ( 5 )$$

When both the distance r₁ and the distance r₂ are between specific frequency bands C₁ and C₂ and the relation of C₁≤r₁≤r₂≤C₂ is satisfied, the information processing apparatus calculates the estimation error by using the evaluation function in Expression (3) on condition that there is at least one or more combinations of the frequency coordinates (u′₁, v′₁) and the frequency coordinates (u′₂, v′₂), which satisfy the relation in Expression (6).

$$\vert F ( {u}_{1}^{′} , {v}_{1}^{′} ) \vert < \vert F ( {u}_{2}^{′} , {v}_{2}^{′} ) \vert \qquad ( 6 )$$

The reason why both the distance r₁ and the distance r₂ are limited between the specific frequency bands C₁ and C₂ as described above is to prevent an error of a high frequency component from having too large an influence since the high frequency component generally contains a large error.

The information processing apparatus executes machine learning on the auto-encoder type neural network so as to reduce an estimation error calculated by the evaluation function.

As described above, the information processing apparatus according to the embodiment inputs the first frequency image to the auto-encoder type neural network, and acquires the second frequency image. When evaluating the difference between the first frequency image and the second frequency image, the information processing apparatus calculates the estimation error by using the evaluation function in Expression (3). In the evaluation function, a weight related to a first frequency is smaller than a weight related to a second frequency (frequency higher than first frequency). This enables the difference between the first frequency image and the second frequency image to be uniformly evaluated regardless of the frequency (frequency coordinates) of a frequency image, and enables machine learning using the frequency image to be accurately executed.

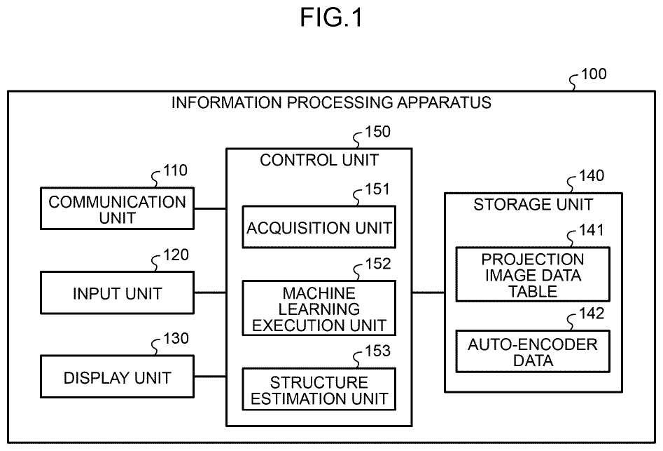

Next, a configuration example of the information processing apparatus that executes the above-described processing will be described. FIG. 1 is a functional block diagram illustrating a configuration of the information processing apparatus according to the embodiment. As illustrated in FIG. 1, an information processing apparatus 100 includes a communication unit 110, an input unit 120, a display unit 130, a storage unit 140, and a control unit 150.

The communication unit 110 executes data communication with an external device or the like via a network. For example, the communication unit 110 receives data of a projection image data table 141 from the external device or the like.

A user operates the input unit 120 when various types of information are input to the control unit 150 of the information processing apparatus 100.

The display unit 130 displays information output from the control unit 150.

The storage unit 140 includes the projection image data table 141 and auto-encoder data 142. The storage unit 140 may have other information.

The projection image data table 141 holds data of a plurality of projection images. For example, projection images of the projection image data table 141 are two-dimensional images obtained by projecting an actual protein (three-dimensional density structure) in certain projection directions θ and ϕ. The projection image data table 141 may hold a projection image in association with information on a projection direction set in a case where the projection image is generated.

The auto-encoder data 142 relates to an auto-encoder type neural network. For example, the auto-encoder type neural network corresponds to the auto-encoder type neural network in FIG. 5, and includes the encoder 10a and the decoder 10b.

The control unit 150 includes an acquisition unit 151, a machine learning execution unit 152, and a structure estimation unit 153.

The acquisition unit 151 acquires data of the projection image data table 141 from an external device or the like via the communication unit 110. The acquisition unit 151 registers the acquired projection image data table 141 in the storage unit 140. The acquisition unit 151 may acquire data on a projection direction or a projection image from the input unit 120.

The machine learning execution unit 152 reads the auto-encoder data 142, executes the auto-encoder type neural network, and executes machine learning on the auto-encoder type neural network. The auto-encoder type neural network includes the encoder 10a and the decoder 10b. An example of processing of the machine learning execution unit 152 will be described below.

The machine learning execution unit 152 acquires a projection image and a projection direction from the projection image data table 141. The machine learning execution unit 152 generates the first frequency image by executing Fourier transform on the acquired projection image. The machine learning execution unit 152 inputs the first frequency image to the encoder 10a, and acquires the output result z from the encoder 10a. The machine learning execution unit 152 acquires an estimation result of the three-dimensional density structure in Fourier space from the decoder 10b by inputting the output result z and information on the projection direction to the decoder 10b.

The machine learning execution unit 152 acquires the second frequency image by projecting the three-dimensional density structure of the estimation result in a predetermined projection direction. For example, the predetermined projection direction corresponds to the projection image acquired from the projection image data table 141.

The machine learning execution unit 152 obtains an estimation error by cumulatively adds differences between values of frequency coordinates of the first frequency image and values of frequency coordinates of the second frequency image based on the evaluation function in Expression (3). The machine learning execution unit 152 executes machine learning on the auto-encoder type neural network so as to reduce the estimation error. For example, the machine learning execution unit 152 updates parameters of the encoder 10a and the decoder 10b of the auto-encoder type neural network based on an error backpropagation training method.

The machine learning execution unit 152 trains the auto-encoder type neural network by repeatedly executing the above-described processing based on the projection images stored in the projection image data table 141.

Incidentally, although using “u′², v′²” as the correction filter coefficient F(u′, v′) in a case where an estimation error is calculated, the machine learning execution unit 152 may use a value proportional to “u′², v′²” instead of “u′², v′²”.

Furthermore, although, when calculating the estimation error, the machine learning execution unit 152 multiplies all the frequency coordinates on the frequency images (first and second frequency images) by the correction filter coefficient, this is not a limitation. When the sum “u′₂²+v′₂²” of the squares of values set in the certain frequency coordinates (u′₂, v′₂) of the frequency image is equal to or less than a threshold, the machine learning execution unit 152 uses a value proportional to “u′₂²+v′₂²” as the correction filter coefficient F(u′, v′). In contrast, when the sum “u′₂²+v′₂²” of the squares of values set in the certain frequency coordinates (u′₂, v′₂) of the frequency image is not equal to or less than the threshold, the machine learning execution unit 152 uses “0” as the correction filter coefficient F(u′, v′).

Since, in the conventional technique, the correction filter coefficient F(u′, v′)=1 holds regardless of the distance r from the origin to the frequency coordinates (u′, v′) of the frequency image, a high frequency is greatly cut in a high frequency component having a large r, which leads to a low contribution to a difference between high frequencies. Therefore, the machine learning execution unit 152 introduces a certain positive number δ, and sets the correction filter coefficient F(u′, v′) such that O(F(u′, v′))≥O(r^{δ) holds.}

Note that the machine learning execution unit 152 may calculate the estimation error by using an evaluation function in Expression (7) using a parameter σ for controlling the weight of each frequency of the correction filter coefficient F(u′, v′). H(u, v) in Expression (7) is represented by Expression (8), and represents Fourier transform of a Gaussian filter with variance σ² to the frequency image.

$${\sum }_{{u}^{′} , {v}^{′}} {{P}_{θ , ϕ} ( {u}^{′} , {v}^{′} )}^{2} {H ( u , v )}^{2} ( {u}^{′2} + {v}^{′2} ) \qquad ( 7 )$$

$$H ( u , v ) = \frac{{σ}^{2}}{2 π} exp ( - \frac{{u}^{2} + {v}^{2}}{2 ( 1 / {σ}^{2} )} ) \qquad ( 8 )$$

The structure estimation unit 153 estimates the three-dimensional density structure based on the auto-encoder type neural network trained by the machine learning execution unit 152.

For example, the structure estimation unit 153 acquires a target projection image from the input unit 120 or the like. The structure estimation unit 153 generates a frequency image by performing Fourier transform on the projection image.

The structure estimation unit 153 inputs the frequency image to the trained auto-encoder type neural network, and estimates the three-dimensional density structure in the Fourier space. The structure estimation unit 153 estimates the three-dimensional density structure in real space by executing inverse Fourier transform on the three-dimensional density structure in the Fourier space. The structure estimation unit 153 outputs the estimation result to the display unit 130, and displays the estimation result on the display unit 130.

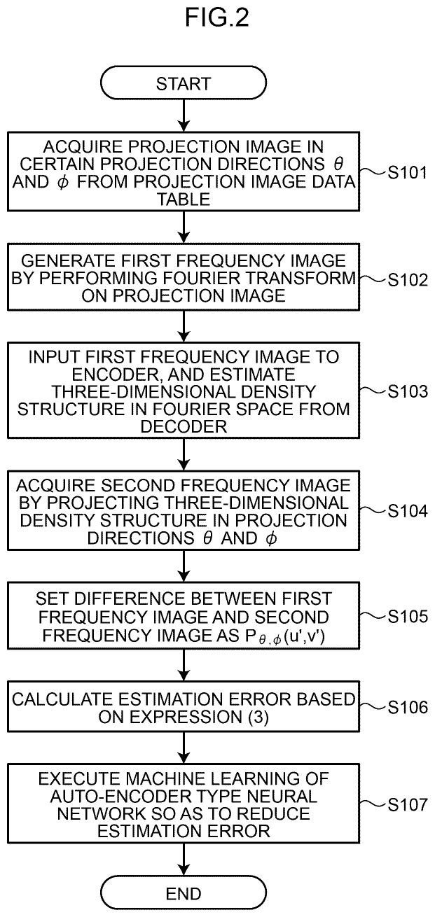

Next, a procedure of processing in which the information processing apparatus 100 according to the embodiment executes machine learning of the auto-encoder type neural network will be described. FIG. 2 is a flowchart illustrating a processing procedure of the information processing apparatus according to the embodiment. The machine learning execution unit 152 of the information processing apparatus 100 acquires a projection image in the certain projection directions θ and ϕ from the projection image data table 141 (Step S101).

The machine learning execution unit 152 generates the first frequency image by performing Fourier transform on the projection image (Step S102). The machine learning execution unit 152 inputs the first frequency image to the encoder 10a, and estimates the three-dimensional density structure in the Fourier space from the decoder 10b (Step S103).

The machine learning execution unit 152 acquires the second frequency image by projecting the three-dimensional density structure in the projection directions θ and ϕ (Step S104). The machine learning execution unit 152 sets the difference between the first frequency image and the second frequency image at frequency coordinates as “P_{θ,ϕ}(u′, v′)” (Step S105).

The machine learning execution unit 152 calculates the estimation error based on Expression (3) (Step S106). The machine learning execution unit 152 executes machine learning of the auto-encoder type neural network so as to reduce the estimation error (Step S107).

Next, effects of the embodiment will be described. The information processing apparatus 100 inputs the first frequency image to the auto-encoder type neural network, and acquires the second frequency image. When evaluating the difference between the first frequency image and the second frequency image, the information processing apparatus 100 calculates the estimation error by using the evaluation function in Expression (3). In the evaluation function, a weight related to a first frequency is smaller than a weight related to a second frequency (frequency higher than first frequency). This enables the difference between the first frequency image and the second frequency image to be uniformly evaluated regardless of the frequency (frequency coordinates) of a frequency image, and enables machine learning using the frequency image to be accurately executed.

When the sum “u′₂²+v′₂²” of the squares of values set in the certain frequency coordinates (u′₂, v′₂) of the frequency image is equal to or less than a threshold, the information processing apparatus 100 uses a value proportional to “u′₂²+v′₂²” as the correction filter coefficient F(u′, v′). In contrast, when the sum “u′₂²+v′₂²” of the squares of values set in the certain frequency coordinates (u′₂, v′₂) of the frequency image is not equal to or less than the threshold, the information processing apparatus 100 uses “0” as the correction filter coefficient F(u′, v′). This can inhibit the contribution of a high frequency having a larger influence of noise than a low frequency from being excessively increased.

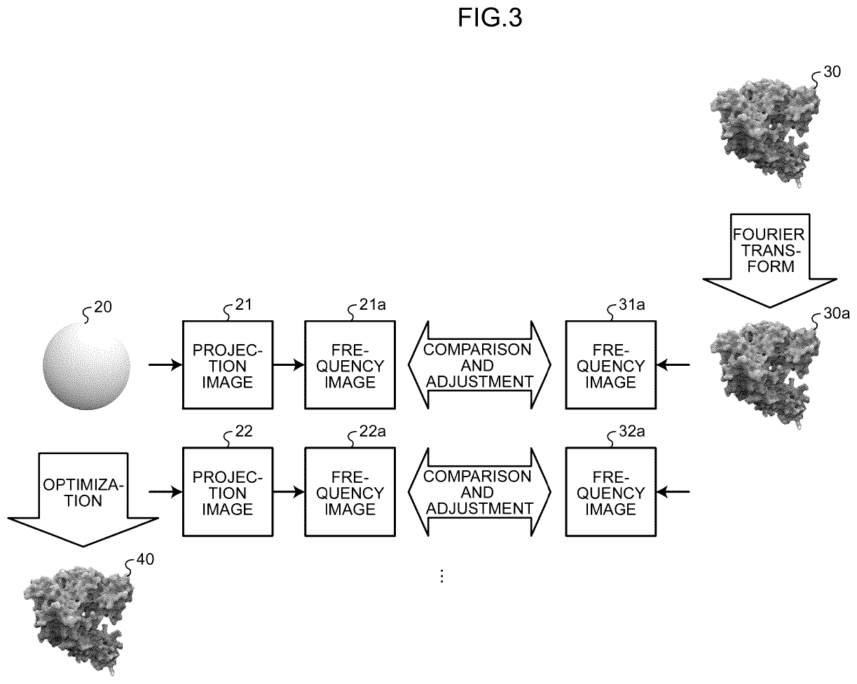

Incidentally, the above-described information processing apparatus 100 can also apply the above-described idea to optimization of the three-dimensional density structure. FIG. 3 illustrates an example of optimization of the three-dimensional density structure.

A case where a three-dimensional density structure 20 in real space is optimized to a three-dimensional density structure 30 in the real space will be described with reference to FIG. 3. For example, the three-dimensional density structure 20 is an estimation target. The information processing apparatus 100 generates a projection image 21 by projecting the three-dimensional density structure 20 in a first projection direction. The information processing apparatus 100 generates a frequency image 21a by executing two-dimensional Fourier transform on the projection image 21.

In contrast, the information processing apparatus 100 generates a three-dimensional density structure 30a in Fourier space by executing three-dimensional Fourier transform on the actual three-dimensional density structure 30. The information processing apparatus 100 generates a frequency image 31a by projecting the three-dimensional density structure 30a in the first projection direction.

The information processing apparatus 100 calculates an estimation error by calculating the differences between the frequency image 21a and the frequency image 31a at frequency coordinates and cumulating values obtained by multiplying the calculated differences by the correction filter coefficient F(u′, v′). The information processing apparatus 100 adjusts the values of the frequency coordinates of the frequency image 21a so as to reduce the estimation error.

Subsequently, the information processing apparatus 100 generates a projection image 22 by projecting the three-dimensional density structure 20 in a second projection direction different from the first projection direction. The information processing apparatus 100 generates a frequency image 22a by executing two-dimensional Fourier transform on the projection image 22.

The information processing apparatus 100 generates a frequency image 32a by projecting the three-dimensional density structure 30a in the second projection direction.

The information processing apparatus 100 calculates an estimation error by calculating the differences between frequency coordinates of the frequency image 22a and those of the frequency image 32a and cumulating values obtained by multiplying the calculated differences by the correction filter coefficient F(u′, v′). The information processing apparatus 100 adjusts the values of the frequency coordinates of the frequency image 22a so as to reduce the estimation error.

Similarly, the information processing apparatus 100 obtains an adjusted frequency image by repeatedly executing the above-described processing on a frequency image, which has been obtained by performing Fourier transform on a projection image obtained by projecting the three-dimensional density structure 20 in another projection direction. The information processing apparatus 100 acquires adjusted projection images by performing inverse Fourier transform on adjusted frequency images, and generates a three-dimensional density structure 40 in the real space based on the projection images. This enables the information processing apparatus 100 to optimize the three-dimensional density structure 20 to the three-dimensional density structure 40. The control unit 150 of the information processing apparatus 100 may execute the processing described with reference to FIG. 3.

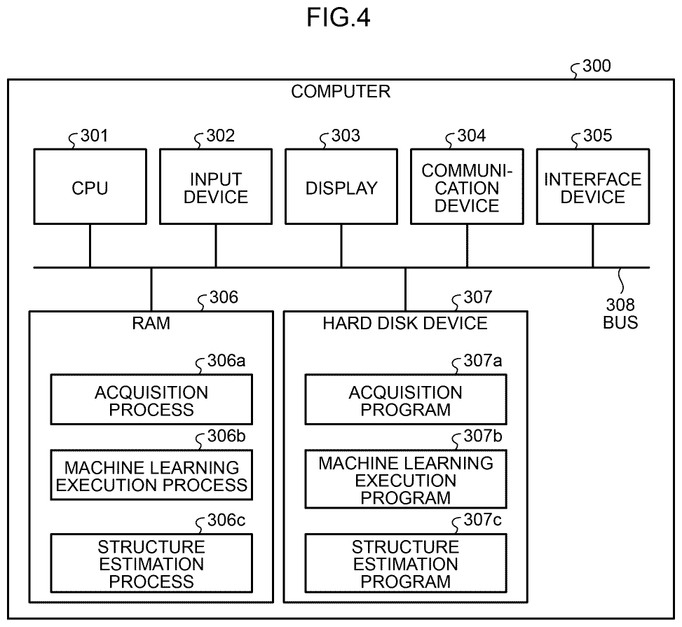

Next, an example of a hardware configuration of a computer that implements functions similar to those of the information processing apparatus 100 described above will be described. FIG. 4 illustrates the example of a hardware configuration of a computer that implements functions similar to those of the information processing apparatus of the embodiment.

As illustrated in FIG. 4, a computer 300 includes a CPU 301, an input device 302, and a display 303. The CPU 301 executes various kinds of arithmetic processing. The input device 302 receives data input from the user. Furthermore, the computer 300 includes a communication device 304 and an interface device 305. The communication device 304 exchanges data with an external device or the like via a wired or wireless network. Furthermore, the computer 300 includes a RAM 306 and a hard disk device 307. The RAM 306 temporarily stores various types of information. Furthermore, devices 301 to 307 are connected to a bus 308.

The hard disk device 307 includes an acquisition program 307a, a machine learning execution program 307b, and a structure estimation program 307c. Furthermore, the CPU 301 reads the programs 307a to 307c, and develops the programs in the RAM 306.

The acquisition program 307a functions as an acquisition process 306a. The machine learning execution program 307b functions as a machine learning execution process 306b. The structure estimation program 307c functions as a structure estimation process 306c.

Processing of the acquisition process 306a corresponds to the processing of the acquisition unit 151. Processing of the machine learning execution process 306b corresponds to the processing of the machine learning execution unit 152. Processing of the structure estimation process 306c corresponds to the processing of the structure estimation unit 153.

Note that the programs 307a to 307c does not necessarily need to be stored in the hard disk device 307 from the beginning. For example, the programs are stored in a “portable physical medium”, such as a flexible disk (FD), a CD-ROM, a DVD, a magneto-optical disk, and an IC card, to be inserted into the computer 300. Then, the computer 300 may read and execute the programs 307a to 307c.

The following supplementary notes are disclosed in relation to embodiments including the above-described embodiment.

(Supplementary Note 1) A machine learning program that causes a computer to execute a process comprising:
acquiring a second frequency image by inputting output of an encoder that has input a first frequency image to a decoder; and
training the encoder and the decoder based on a loss function in which a weight related to a first frequency is smaller than a weight related to a second frequency higher than the first frequency, the first frequency image, and the second frequency image.

(Supplementary Note 2) The machine learning program according to Supplementary Note 1, in which the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

(Supplementary Note 3) The machine learning program according to Supplementary Note 1, in which, the acquiring includes, estimating a three-dimensional density structure is estimated by inputting output of the encoder that has input the first frequency image to the decoder, and acquiring the second frequency image based on the three-dimensional density structure.

(Supplementary Note 4) The machine learning program according to Supplementary Note 2, in which, the training the encoder and the decoder, when a value based on a certain frequency coordinate of the first frequency image or the second frequency image is larger than a threshold, further includes setting a difference between the first frequency image and the second frequency image at the certain frequency coordinate to 0 is further executed.

(Supplementary Note 5) The machine learning program according to Supplementary Note 2, in which the loss function further includes a Gaussian filter, and, in the processing of training the encoder and the decoder, the encoder and the decoder are trained based on an estimation error calculated based on the loss function further including the Gaussian filter.

(Supplementary Note 6) An optimization program that causes a computer to execute a process comprising:
multiplying a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjusting a value of the first frequency image so as to reduce a multiplication result.

(Supplementary Note 7) A machine learning method carried out by a computer, comprising:
acquiring a second frequency image by inputting output of an encoder that has input a first frequency image to a decoder; and
training the encoder and the decoder based on a loss function in which a weight related to a first frequency is smaller than a weight related to a second frequency higher than the first frequency, the first frequency image, and the second frequency image.

(Supplementary Note 8) The machine learning method according to Supplementary Note 7, in which the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

(Supplementary Note 9) The machine learning method according to Supplementary Note 7, in which, the acquiring includes, estimating a three-dimensional density structure is estimated by inputting output of the encoder that has input the first frequency image to the decoder, and acquring the second frequency image based on the three-dimensional density structure.

(Supplementary Note 10) The machine learning method according to Supplementary Note 8, in which, the training, when a value based on a certain frequency coordinate of the first frequency image or the second frequency image is larger than a threshold, further includes setting a difference between the first frequency image and the second frequency image at the certain frequency coordinate to 0.

(Supplementary Note 11) The machine learning method according to Supplementary Note 8, in which the loss function further includes a Gaussian filter, and, in the processing of training the encoder and the decoder, the encoder and the decoder are trained based on an estimation error calculated based on the loss function further including the Gaussian filter.

(Supplementary Note 12) An optimization method carried out by a computer, comprising:
multiplying a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjusting a value of the first frequency image so as to reduce a multiplication result.

(Supplementary Note 13) An information processing apparatus including a control unit configured to execute a process comprising:
acquiring a second frequency image by inputting output of an encoder that has input a first frequency image to a decoder; and
training the encoder and the decoder based on a loss function in which a weight related to a first frequency is smaller than a weight related to a second frequency higher than the first frequency, the first frequency image, and the second frequency image.

(Supplementary Note 14) The information processing apparatus according to Supplementary Note 13, in which the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

(Supplementary Note 15) The information processing apparatus according to Supplementary Note 13, in which, the acquiring further includes, estimating a three-dimensional density structure is estimated by inputting output of the encoder that has input the first frequency image to the decoder, and acquiring the second frequency image based on the three-dimensional density structure.

(Supplementary Note 16) The information processing apparatus according to Supplementary Note 14, in which, the training, when a value based on a certain frequency coordinate of the first frequency image or the second frequency image is larger than a threshold, further includes setting a difference between the first frequency image and the second frequency image at the certain frequency coordinate to 0.

(Supplementary Note 17) The information processing apparatus according to Supplementary Note 14, in which the loss function further includes a Gaussian filter, and, in the processing of training the encoder and the decoder, the encoder and the decoder are trained based on an estimation error calculated based on the loss function further including the Gaussian filter.

(Supplementary Note 18) An information processing apparatus including a control unit configured to execute a process comprising:
multiplying a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjusting a value of the first frequency image so as to reduce a multiplication result.

Machine learning using a frequency image can be accurately executed.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a machine learning program that causes a computer to execute a process comprising:
acquiring a second frequency image by inputting output of an encoder that has input a first frequency image to a decoder; and
training the encoder and the decoder based on a loss function in which a weight related to a first frequency is smaller than a weight related to a second frequency higher than the first frequency, the first frequency image, and the second frequency image.

2. The non-transitory computer-readable recording medium according to claim 1, wherein the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

3. The non-transitory computer-readable recording medium according to claim 1, wherein the acquiring includes
estimating a three-dimensional density structure by inputting output of the encoder that has input the first frequency image to the decoder, and
acquiring the second frequency image based on the three-dimensional density structure.

4. The non-transitory computer-readable recording medium according to claim 2, wherein the training the encoder and the decoder, when a value based on a certain frequency coordinate of the first frequency image or the second frequency image is larger than a threshold, further inlcudes setting a difference between the first frequency image and the second frequency image at the certain frequency coordinate to 0.

5. The non-transitory computer-readable recording medium according to claim 2, wherein the loss function further includes a Gaussian filter, and, in the processing of training the encoder and the decoder, the encoder and the decoder are trained based on an estimation error calculated based on the loss function further including the Gaussian filter.

6. A non-transitory computer-readable recording medium having stored therein an optimization program that causes a computer to execute a process comprising:
multiplying a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjusting a value of the first frequency image so as to reduce a multiplication result.

7. A machine learning method comprising:
acquiring a second frequency image by inputting output of an encoder that has input a first frequency image to a decoder; and
training the encoder and the decoder based on a loss function in which a weight related to a first frequency is smaller than a weight related to a second frequency higher than the first frequency, the first frequency image, and the second frequency image, using a processor.

8. The machine learning method according to claim 7, wherein the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

9. The machine learning method according to claim 7, wherein, the acquiring includes
estimating a three-dimensional density structure is estimated by inputting output of the encoder that has input the first frequency image to the decoder, and
acquiring the second frequency image based on the three-dimensional density structure.

10. The machine learning method according to claim 8, wherein, the training, when a value based on a certain frequency coordinate of the first frequency image or the second frequency image is larger than a threshold, further inlcudes setting a difference between the first frequency image and the second frequency image at the certain frequency coordinate to 0.

11. The machine learning method according to claim 8, wherein the loss function further includes a Gaussian filter, and, in the processing of training the encoder and the decoder, the encoder and the decoder are trained based on an estimation error calculated based on the loss function further including the Gaussian filter.

12. An optimization method comprising:
multiplying a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjusting a value of the first frequency image so as to reduce a multiplication result, using a processor.

13. An information processing apparatus comprising:
a processor configured to:
acquire a second frequency image by inputting output of an encoder that has input a first frequency image to a decoder; and
train the encoder and the decoder based on a loss function in which a weight related to a first frequency is smaller than a weight related to a second frequency higher than the first frequency, the first frequency image, and the second frequency image.

14. The information processing apparatus according to claim 13, wherein the loss function is used for calculating an estimation error by cumulating values obtained by multiplying a difference between the first frequency image and the second frequency image at each frequency coordinate by a weight in which a weight related to the first frequency is smaller than a weight related to a second frequency higher than the first frequency, and, in processing of training the encoder and the decoder, the encoder and the decoder are trained based on the estimation error.

15. The information processing apparatus according to claim 13, wherein the processor is further configured to:
estimate three-dimensional density structure is estimated by inputting output of the encoder that has input the first frequency image to the decoder, and
acquire the second frequency image based on the three-dimensional density structure.

16. The information processing apparatus according to claim 14, wherein the processor is further configured to, when a value based on a certain frequency coordinate of the first frequency image or the second frequency image is larger than a threshold, set a difference between the first frequency image and the second frequency image at the certain frequency coordinate to 0.

17. The information processing apparatus according to claim 14, wherein the loss function further includes a Gaussian filter, and, in the processing of training the encoder and the decoder, the encoder and the decoder are trained based on an estimation error calculated based on the loss function further including the Gaussian filter.

18. An information processing apparatus comprising:
a processor configured to:
multiply a difference between a first frequency image based on a projection image obtained by projecting a first three-dimensional density structure in a certain projection direction and a second frequency image obtained by projecting a second three-dimensional density structure in Fourier space in the certain projection direction by a weight in which a weight related to a first frequency is smaller than a weight related to a second frequency higher than the first frequency; and
adjust a value of the first frequency image so as to reduce a multiplication result.
